(19) United States
(12) Patent Application Publication
(10) Pub. No.: US 2002/0152196 A1
(43) Pub. Date: Oct. 17, 2002

(54) cDNA database and biochip for analysis of hematopoietic tissue

(76) Inventors: Carol A. Westbrook, Chicago, IL (US); Ronald Hoffman, Chicago, IL (US)

Correspondence Address: BARNES & THORNBURG, 2600 CHASE PLAZA, 10 LASALLE STREET, CHICAGO, IL, 60603

(21) Appl. No.: 09/897,798

(22) Filed: Jul. 2, 2001

Related U.S. Application Data
(60) Provisional application No. 60/216,829, filed on Jul. 7, 2000.

(51) Int. Cl. G06F 7/00

(52) U.S. Cl. 707/1

(57) ABSTRACT

A unique database, a “transcriptosome” of a primate CD34+ cell, was compiled which is useful for the analysis and transplantation of bone marrow. Research and clinical applications arise from analysis of bone marrow, and related hemotopoietic tissues, prior to gene therapy or transplantation. Because the database contains many unknown and uncharacterized genes, an important use is the discovery of new genes that are relevant to hematopoiesis and stem cell growth. These genes may lead to further commercial products.

### BACKGROUND OF THE INVENTION

This application claims priority from Ser. No. 60/216829 filed Jul. 7, 2000.

A unique database, a “transcriptosome” of a primate CD34+ cell, was compiled which is useful for the analysis of hematopoietic tissue. Research and clinical applications arise from analysis of bone marrow, peripheral blood or cord blood prior to gene therapy or transplantation of bone marrow, for example. Molecules with nucleotide sequences that are in the database may be placed in arrays on microchips for various applications.

Although the human genome has been sequenced, meaningful groupings and uses of the sequences are just beginning. Specific purpose databases (datasets) are not available for bone marrow and related tissues.

The concept of cDNA arrays has already been developed, and the technology is widely available. However, creation of databases by selecting genes according to a plan and/or specific uses or functions, to put on chips, is still an active area of research. An example is the “lymphoma chip” that was recently reported, which contained arrays of genes used for diagnosis of lymphoma (Alizadeh et al., 2000).

To prepare an array so that it can be used for a specified purpose, some sort of support is generally needed. For example, cDNA chips are solid supports (usually glass slides or filter membranes) containing DNA fragments from a specific plurality of cDNAs, ESTs, or control molecules organized in 2-dimensional patterned arrays, which are used for hybridization to RNA or DNA probes. The chips are used, for example, to detect the presence, as well as the relative level of expression of each DNA of the array in a target sample. The technology of cDNA arrays and of signal quantitation is well-developed, but specific uses of the arrays, the nature of the DNA to be placed on the chips, and medical application of chips is still under investigation. Moreover, the term “chip” is becoming broad. “Microarry” means that a plurality of very small molecules are included.

### SUMMARY OF THE INVENTION

The invention includes a database that is a set of nucleotide sequences for cDNA molecules including those for genes with known functions, in addition to genes with unknown functions, and ESTs (expressed sequence tags). The database is useful for the identification of genes relevant to hematopoiesis, and for the preparation of a microarray chip (“microchip” or “biochip”) or other physical manifestation of an array that can be used to analyze hematopoietic tissue (bone marrow, peripheral blood, leukemia cells) for clinical applications such as bone marrow transplantation, and for research in human and other primate studies relating to hematopoiesis. The unique aspects of this invention include the method in which the genes were identified as significantly expressed in bone marrow, the preliminary and expanded gene list (the database), the concept of using the gene list as a stem cell or hematopoiesis-specific database, the concept of using the gene list for a cDNA chip, and the application of the cDNA chip for clinical and research purposes.

### BRIEF DESCRIPTION OF THE DRAWINGS

FIG. 1 shows the correlation of gene expression between human and baboon CD34⁺ cells. The normalized intensities of all the data points (25,920) from five releases of GeneFilters (GF200-GF204) hybridized to the baboon-derived CD34⁺ probe were compared to those resulting from the human-derived CD34⁺ probe by scatter analysis, using Microsoft Excel software.

FIG. 2 lists abundance categories of the common genes in human and baboon CD34⁺ cells. A total of 15,407 cDNAs whose expression varies less than 3-fold between human and baboon CD34+ RNAs were arbitrarily grouped into four relative expression categories, from low to very high abundance. The categories, based on the signal intensity of the human RNA relative filter background, are as follows: no expression (<3-fold), low abundance (3-fold to <10-fold), intermediate (10-fold to<25-fold), high (25-fold to <100-fold ), and very high abundance (100-fold and higher).

FIG. 3 compares the expression level between human and baboon CD34⁺ cells for genes selected from different abundance categories, by semi-quantitative RT-PCR. Five known genes representative of each of the abundance categories described in FIG. 2 were analyzed by RT-PCR using primers from the 3′-untranslated region of the gene. The PCR reactions were done with (+) or without (−) addition of reverse transcriptase (RT) for the indicated cycle number (Cy). The genes tested are: TM4SF4, transmembrane 4 superfamily member 4; PTK9, protein tyrosine kinase 9; CYP1B1, cytochrome P450, subfamily 1 (dioxine-inducible), polypeptide 1 (glaucoma 3, primary infantile); CSF3R, colony stimulating factor 3 receptor; B2M, β₂-microglobulin. The intensity measured with GeneFilters was compared to that measured by RT-PCR.

FIG. 4 compares the expression level between human and baboon CD34⁺ cells for apparent species-specific genes selected from Table 3. Representative analysis by semiquantitative RT-PCR for three transcripts from Table 3 with apparent species-specific expression as measured on GeneFilters , using primers designed from the 3′-untranslated region of the gene. The PCR reactions were done with (+) or without (−) addition of reverse transcriptase (RT) for the indicated cycle number (Cy). The intensity measured with Gene Filters (GF) is compared to that measured by RT-PCR, normalized to genomic DNA. Intensity ratio measurement are shown as positive when expression in humans is higher than baboons, and negative when the reverse is true.

### DESCRIPTION OF THE INVENTION

The invention relates a database (“transcriptosome”) of a primate CD34+ cell that includes sequences selected by methods of the present invention.

Because the database contains many unknown and uncharacterized genes, an important use of the invention is to discover new genes that are relevant to hematopoiesis and stem cell growth. The database also has value because it could be mined for specific gene discovery, for example to find new genes that are surface markers (e.g. for flow cytometry), growth factors, or receptors for growth factors that regulate stem cell growth. The database itself may have commercial use in its entirety for the preparation of chips, which could be used to diagnose or analyze hematopoietic cancers, and to evaluate normal bone marrow or stem cells prior to transplantation.

More particularly, the invention relates to a database that is a dataset which specifies the majority of genes expressed at moderate levels or higher in human hematopoietic tissue, as represented by CD34+ cells from bone marrow, and their approximate rank order by level of expression. The genes in this database refer to partial sequences that are available in the Human Genome databases, and thus can be analyzed directly by reference to their unique ID numbers. The database has value because it can be mined to identify abundant mRNAs coding for proteins of interest in many categories with therapeutic, research, and diagnostic applications. The gene list, or a subset thereof, is useful to prepare a cDNA chip with applications to hematopoiesis.

Alternatively, the gene list can be mined without preparing a chip from it. The preparation of a chip is one aspect of the invention and use of the database.

An aspect of the invention is a standard size cDNA chip (5,000 to 10,000 elements) constructed to contain genes expressed in human bone marrow, specifically those that are expressed in the CD34+ fraction, the fraction which contains the undifferentiated cells that give rise to stem cells and which contains transplantable elements. The cDNA composition of a chip made in this fashion is representative of genes that are expressed at moderate to high levels by human bone marrow cells in their native stage (natural, in vivo), and those genes whose expression might change with physiologic or pharmacologic manipulation, as well as those genes used as internal controls. However, other compositions of cDNA molecules are within the scope of the invention.

The invention also relates the composition of a chip, that is, the selection of DNA molecules to array (position on the support in accord with a plan, or strategy) on the chip, which is based on the results of a novel experimental method. The invention also specifies some of the uses of the chip, which include analysis of human bone marrow, peripheral blood or cord blood prior to transplantation to determine if the transplanted tissue will engraft; analysis of human bone marrow, peripheral blood or cord blood after it has been treated with approved or experimental manipulations (e.g. growth factors, purging, gene therapy, and the like) prior to transplantation, to determine if the transplantation will engraft, or to determine the effects of treatment; research in human bone marrow transplantation and ex vivo cellular expansion; discovery of new genes related to human hematopoiesis or stem cell growth; similar research in non-human primate system, with the aim of applying the research results to human systems.

A cDNA chip called, for example, the “Stem Cell Chip” is useful as a substrate for hybridization of RNA derived from human clinical or research samples, including hematopoeitic stem cells obtained from sources such as bone marrow, peripheral blood, or cord blood; or from similar samples obtained from primate bone marrow for research purposes. The term “the chip” used hereinafter includes a plurality of chips either of similar or different compositions.

RNA is used to prepare a probe using standard methods (reverse-transcription, labeling by fluorescent or radioactive nucleotides), and the RNA is hybridized to the Stem Cell Chip. Hybridization occurs between homologous sequences—the degree of homology required for hybridization depends on the conditions under which the hybridization takes place, e.g., temperature, pH. Hybridization to each cDNA molecule on the array is detected and quantitated. The pattern and the relative intensity of hybridization of the probes with each cDNA on the array is expected to vary with the population tested. Individual hybridization patterns and intensity levels define “clusters” of gene expression that are used to define physiologic conditions. For example, the chip may be applied to analyze a bone marrow that was treated with gene therapy, to determine if the marrow is likely to engraft for transplantation. The expression of genes on the chip would be compared to that level of expression needed for a successful graft. Another novel use of the chip is the study of experimental methods applied to non-human primates, particularly baboons. Because the chip is expected to be similarly representative of both human and baboon marrow, the use of this chip to analyze baboon marrow (stem cells or cord blood) makes it possible to directly apply the animal results to human systems. Because the chip may contain many uncharacterized gene fragments in the form of ESTs, an important use is in the discovery of new genes that are relevant to hematopoiesis and stem cell growth. Their relevancy is based on their inclusion on the gene list, and also by experimental uses of the chip such as to determine results of treatment, or comparisons of populations.

Highly-abundant Genes in the Transcriptosome of Human and Baboon CD34 Antigen-positive Bone Marrow Cells

Non-human primates are useful large animal model systems for the in vivo study of hematopoietic stem cell biology. To ascertain and analyze the degree of similarity of the hematopoietic systems between humans and baboons, and to explore the relevance of such studies in non-human primates to humans, the global gene expression profiles of bone marrow CD34⁺ cells isolated from these two species were compared. Human cDNA filter arrays containing 25,920 human cDNAs were surveyed. The expression pattern and relative gene abundance of the two RNA sources was similar, with a correlation coefficient of 0.87. A total of 15,970 of these cDNAs were expressed in human CD34⁺ cells, of which the majority (96%) varied less than 3-fold in their relative level of expression between human and baboon. RT-PCR analysis of selected genes confirmed that expression was comparable between the two species. No species-restricted transcripts have been identified, further reinforcing the high degree of similarity between the two populations. A subset of 1554 cDNAs which are expressed at levels 100-fold and greater than background is described, which includes 959 ESTs and uncharacterized cDNAs, and 595 named genes, including many that are clearly involved in hematopoiesis. The cDNAs reported here represent a selection of some of the most highly-abundant genes in hematopoietic cells, and provide a starting point to develop a profile of the transcriptosome of CD34⁺ cells.

Non-human primates are important experimental models for hematopoietic stem cell transplantation and biology, because the behavior of hematopoietic stem and progenitor cells in primates closely resembles that in man (Andrews et al., 1992; Brandt et al., 1999; Goodell et al., 1997). The use of non-human primates permits a degree of experimental freedom to perturb hematopoiesis not possible in man, which might end in a genetic analysis of hematopoiesis, not only under steady-state conditions, but also under conditions of stress. The baboon (Papio anubis) is particularly useful in this regard because it is closely related to humans, and shows cross-reactivity with many of the reagents used to study human hematopoiesis. Recent studies have initiated a description of the overall pattern of gene expression in murine bone marrow stem cells (Nachtman et al., 2000; Phillips et al., 2000), but by contrast, relatively little is known of the expression patterns of human bone marrow hematopoietic stem cells or the baboon marrow stem and progenitor cells. To study baboon hematopoiesis, and facilitate extrapolation into human systems, the expression profiles of human tissue for each species were compared. Human and baboon bone marrow cells which were positive for the CD34 antigen (CD34⁺ cells) were used for these comparisons, because they represent a marrow fraction enriched for both primitive hematopoietic stem and progenitor cells (Link et al., 1996; Pierelli et al., 2000; Ueda et al., 2000).

Human cDNA filter arrays were used to establish the expression profiles for both species, because there is no comparable product available for baboon cDNA analysis, and a high nucleotide sequence homology between these two species was expected (Liao et al., 1998; Trezise et al., 1989). The cDNA filter arrays used (GeneFilters™) contained 25,920 cDNAs from the UniGene dataset (http://www.ncbi.nlm.nih.gov/UniGene/index.html), including both known genes and uncharacterized ESTs, permitting the survey of one-fourth to one half of the estimated 50,000-100,000 genes in the genome. The transcriptosome of CD34⁺ cells, is disclosed herein, demonstrating very comparable gene expression patterns in CD34+ cells in these two species, and validating the utility of human cDNA arrays for baboon studies.

SELECTION OF THE GENE LIST (database): The gene list (database) of this invention was defined using a unique approach combining filter array methodology with cross-species hybridization to identify conserved sequences. Normal human bone marrow from an anonymous donor was fractionated into CD34+ cells by standard methods (using anti-CD34+ antibody to bind and separate out cells). RNA was prepared from the CD34+ cells so obtained, and then used to prepare a hybridization probe by radioactive labeling; the probe was hybridized to a commercially-available cDNA filter array (GeneFilters, release 200-204, purchased from Research Genetics, Huntsville, Ala.), which contained in total 25,900 cDNAs and ESTs from the UniGene set. The 25,900 genes surveyed represent ⅓ to ½ of the estimated 50,000 to 75,000 genes in the human genome. After hybridization of the arrays to the human CD34+ RNA probe, similar probes were prepared from normal baboon marrow cells that had been similarly purified for CD34+ cells. Comparison of the hybridization profiles of the human and baboon marrow made it possible to determine that both had similar expression patterns for the majority of genes. The use of a cross-species hybridization (human and baboon) ensured the selection of genes that were conserved between both species. Thus, the selected genes which are present in both RNAs are expected to be more representative of the tissue, ie.CD34+ cells, than of the individual species. The correlation of human and baboon marrow varied from 88% to 98%, depending on the filter analyzed, with an average correlation of 94%. (To put these figures in perspective, a correlation coefficient of 0.42 was measured when comparing CDE34+ expression on GeneFilters to that obtained for the hematopoietic cell line U937 and a correlation coefficient of 0.57 when comparing human CD34+ cells to HT29 colon cancer cell line).

A set of approximately 9,500 genes was selected using two criteria: all of those expressed at similar levels in both human and baboon (which was defined as a level of expression that varied 3-fold or less between the species) and whose expression in the human was 7-fold or greater than the background level that was measured in the individual GeneFilter experiment (which was arbitrarily assigned to indicate expression at a moderate to high level). A cut-off level of intensity of 3-fold over background is generally taken to indicate expression that is greater than zero, and can be reliably detected and quantitatively measured for the human-based probes. Using this cut-off of 3-fold, the human CD34+ cells displayed approximately 15,970 or 62% of the 25,920 cDNAs present on these filters. The level of 7-fold over background was thus arbitrarily selected as a cut-off for this gene list, recognizing that all of these genes are certain to be actually expressed in the cells, and to provide a dataset that was limited in size to <10,000 genes, and contained those that are expressed at moderate to high levels; a more complete dataset would include the entire 15,970 genes; by extrapolation, this may represent half to third of all of the genes in the CD34+ cells. For some applications, different cut-off levels could be utilized—a higher cut-off would result in fewer genes but they would be a high level, and a lower cut-off would be more inclusive of the entire expression profile of the cell.

Genes from this database were then ranked from highest to lowest level of expression, as determined from their measured intensity in human CD34+ RNA. The rank order is only approximate, because the filters cannot provide the absolute level of expression, and there is experimental error in taking the measurements, but confirmatory experiments for randomly-selected genes have shown a fairly good correlation with rank order and expression measured by other methods. Additions, or corrections to the list may be made within the scope of the invention, but the underlying concept and the majority of the listed genes are as indicated herein. The complete gene list is appended as Appendix A and is available through a web site http://westsun.hema.uic.edu/html/expression.html which will be available to the public upon filing the present patent application. Table 2 shows selective highly-abundant EST's and partially characterized cDNAs in human an baboon CD34+ cells.

The gene filters which were used to identify the genes are commercially available from Research Genetics, but any filter array might have been used. The genes themselves are selected from databases that are in the public domain (UniGene dataset, http://www.ncbi.nim.nih.gov/UniGene/index.html) as part of the Human Genome Program. The invention is to compile a specialized database using the criteria herein for applications involving hematopoeitics.

The genes defined in this invention are represented as UniGene cluster numbers. UniGene (http://www.ncbi.nlm.nih.gov/UniGene/index.html) is a product of the Human Genome Program, maintained by the National Center for Biotechnology Research. UniGene contains over 40,000 entries, each of which represents a unique gene based on a composite of sequences of individual clones from cDNA libraries. The cDNA clones represented in UniGene are available for purchase from a number of repositories, including TIGR (The Institute For Genome Research, http://www.tigr.org/tdb/tdb.html). The dataset and representative clones are publicly available to any investigators, but the clones specified by this invention, and their association as a group with bone marrow and related cell types, and their expression levels, are not publicly available data.

Furthermore, there is currently no commercially available cDNA chip that has genes representative of human bone marrow stem cells and related cell types, nor is there such an extensive database which describes the constitution of genes expressed in human bone marrow. Furthermore, until the present invention, it was not possible to directly translate research results from experimental primate studies (baboon) to humans.

Table 1 shows some of the most abundant cDNAs commonly expressed in human and baboon CD34+ cells. This table displays the first 200 genes from the total genes in Appendix A, or the top 2% (by expression level). Table 1 is derived from the Appendix, that contains the entire gene set, that is those that are >7-times over background in human and less than 3-fold different between species. The column headings, from left to right are:

1. Rank order (based on human expression).

2. CLUSTER ID (refers to the human Unique Gene number, or UniGene number, part of the Human Genome Program. http;H/www.ncbi.nlm.nih.gov/UniGene/index.html)

3. GENBANK the GenBank number of the clone from the UniGene cluster which was placed on GeneFilters and which hybridized to the probe

4. Human expression level (measured experimentally, as normalized intensity).

5. Baboon expression level (measured experimentally, as normalized intensity).

6. Relative expression level, expressed as a ratio of human to baboon, from experimental data.

7. Title-name of gene or EST, extracted by Pathways software (Software from Research Genetics used to interpret the GeneFilters Result) from the UniGene databases.

8. Official gene name, if known.

Note that columns #2, 3, 7 and 8 may be updated as the UniGene databases are updated, but they still refer to the same gene.

### EXAMPLES

### Example 1

### Use of the Hematopoetic Database of the Present Invention to Expand a Stem Cell Graft Ex Vivo

A use of the database is to determine whether a stem cell graft has the same level of gene expression as the hose, or desired stem cells, in particular for genes known to be related to the success of expansion of a stem cell graft ex vivo. To do this, the pattern of gene expression in the host stem cells for genes in the database of the present invention must be analyzed. A comparison is then made of the level of expression of the same genes, in the graft. An embodiment of the invention is to compare expression levels of genes of a subset of genes either highly expressed in stem cells, or known to be predictive of stem cell graft expansion success.

### Example 2

### Use of the Hematopoetic Database of the Present Invention to Determine Whether or Not Genetic Modification Altered the Molecular Signature of Tissue

Gene therapy is used to alter or replace defective genes or to enhance the expression of specific genes.

To determine whether genetic modifications did or did not alter the molecular signature of tissue used in gene therapy, expression levels of genes in the database of the present invention are compared before and after the modifications are made.

Materials and Methods

I. Collection and Selection of CD34+ Marrrow Cells

Healthy adult baboons (Papio anubis) weighing 9-10 kg were used. The animals were housed under conditions approved by the Association for the Assessment and Accreditation of Laboratory Animal Care. Bone marrow aspirates were obtained from the humeri and iliac crest of adult baboons under ketamine and xylazine (1 mg/kg) anesthesia under guidlines established by the Animal Care Committee of the University of Illinois at Chicago. Human bone marrow aspirates from the iliac crest were obtained from normal human adult donors after informed consent was obtained, as approved by the Institutional Review Board of the University of Illinois at Chicago. Marrow mononuclear cells were isolated from the marrow as previously described (Brandt et al, 1999). Briefly, the marrow was heparinized; diluted 1:15 in phosphate-buffered saline (PBS); and fractionated over 60% Percoll (Pharmacia LKB, Uppsala, Sweden) by centrifugation at 500 g for 30 minutes at 20° C. The interphase mononuclear cells were resuspended in PBS containing 0.2% bovine serum albumin and human immune globulin (Sigma Chemical Co, St. Louis, Mo.) and labeled with the biotin conjugated mouse anti-human CD34⁺ antibodies MoAb 12-8 (Andrews et al., 1986) for baboon, and QBAND/10 (Brandt et al., 1998) for human cells, washed, and relabeled with streptavidin conjugated rat anti-mouse antibody-containing iron microbeads (Miltenyi Biotech, Auburn, Calif.). The CD34⁺ cells were then selected by passing the CD34⁺ cell-antibody-iron bead complex through a magnetic column. The purity of the CD34⁺ fraction was estimated by flow cytometry using a fluorescein isothiocyanite (FITC)-conjugated anti-human CD34⁺ antibody K6.1 (Brandt et al, 1999) for baboon cells and MoAb HPCA-2 for human cells.

II. RNA and DNA Preparation

Total RNA was extracted from 1-5×10⁶ human and baboon CD34⁺ cells using an Ultraspec RNA Isolation kit (Biotecx Laboratories, Inc, Houston, Tex.) according to the manufacturer's protocol. The quantity of total RNA was determined by A₂₆₀ absorbance, and quality was verified by analysis on 1% agarose gels using standard techniques. Genomic DNA was prepared from the HL60 human cell line (American Type Culture Collection) and baboon peripheral blood cells using Trizol reagent (Life Technologies) according to the manufacturer's specification.

Uniformly-labeled cDNA probes were prepared from 3 mg of total RNA by priming with 2 mg of oligo-dT, followed by elongation with 1.5 units of Superscript II reverse transcriptase (Life Technologies, Grand Island, N.Y.) in presence of 100 mCi of ³³P dCTP (Amersham Pharmacia Biotech, Piscataway, N.J.). The labeled probe was purified from unincorportated nucleotides and other small molecules with ProbeQuant G-50 (Amersham Pharmacia Biotech).

III. Hybridization of cDNA Probes to GeneFilters

Five releases (GF200-204) of human GeneFilters (Research Genetics, Huntsville, Ala.) were pre-hybridized for 2 hours at 42° C. in MicroHyb solution (Research Genetics), with the addition of 1 μg/ml each of polyA (Research Genetics) and human Cot1 DNA (Life Technologies, Grand Island, N.Y.). The blots were then hybridized overnight in the same MicroHyb solution with the addition of 2×10⁶cpm/ml of heat denatured probe. The blots were washed twice at 50° C. with 2×SSC, 1% SDS for 20 minutes and once at room temperature in 0.5×SSC, 1% SDS with gentle agitation for 15 minutes, prior to imaging. For re-use of membranes, the filters were stripped in 0.5% SDS for 1 hour at room temperature with gentle agitation as recommended by the manufacturer, and was re-exposed to confirm complete stripping.

IV. Exposure, Imaging, and Analysis of Filter Membranes

The hybridized filters were imaged using a phosphor imaging screen (Molecular Dynamics, Sunnyvale, Calif.), exposed for three to four days, imaged using a Storm phosphor imaging system (Molecular Dynamics) at 50-micron resolution, and analyzed using PathwaysII from Research Genetics following the manufacturer's guidelines. Using this program, individual cDNA spots were identified and fit to a grid, and their intensity measurements were recorded as raw intensities. The background for a particular experiment, provided as a reference, was calculated by averaging the measured intensities between the two grids of the filter. This background information was used to assign levels of expression of the genes. Data from poor hybridizations, such as those which had unacceptably high background or non-uniform control spots intensities across the membrane, was not considered for further analysis and discarded. To compare expression of a cDNA spot between two probes that were sequentially hybridized to the same filter, the intensities were normalized using the algorithm provided by the PathwaysII software, using either control spots or all data points as reference. The data were exported as Excel files for further analysis. Since PathwaysII utilizes an older, somewhat outdated version of UniGene (build versions 18, 19 ,39, and 42) and substantial changes have been made in the UniGene database since then, the cDNAs list was updated using UniGene build version 118 as reference (current as of April, 2000). To accomplish this, both the UniGene and GeneFilter dataset were reformatted to Microsoft Access database. The GenBank accession numbers of the GeneFilter dataset were then matched against the UniGene database to update the cluster ID, gene name, and gene description.

V. PCR Analysis

For reverse-transcriptase PCR (RT-PCR), first strand cDNA was generated from approximately 1 mg of RNA that had been DNase-treated with RNase free DNase I (Life Technologies, Grand Island, N.Y.). The RNA was then used to make first strand cDNA in a 20 ml reaction volume with (+RT) or without (−RT) reverse transcriptase using Superscript II Reverse Transcriptase kit from Life Technologies according to the manufacturer's recommended protocol followed by RNase H treatment. If not stated otherwise, 1/20th volume of the +/−RT reaction mix was used for the PCR reaction in presence of 1×PCR buffer (Perkin Elmer Cetus (PE)), 1.5 mM MgCl₂, 200 mM dNTPs, 1 mM each of forward and reverse primers, and 1 U of Amplitaq polymerase (PE) in a 20 ml reaction volume using the following cycles; initial denaturation at 95° C. for 5 min. followed by each cycle at 95° C. for 30 sec., annealing at 58° C./65° C. depending on the primer pair for 30 sec., amplification at 72° C. for 30 sec., the final amplification was for 5 min at 72° C. PCR analysis of genomic DNA was similarly performed, using 200 ng of genomic DNA instead of first strand cDNA.

VI. Comparison of Expression Levels by Semi-quantitative RT-PCR

To compare the expression of individual genes, RT-PCR was performed using primer pairs designed based on the sequence of the cDNA clones that was included on the GeneFilter. The PCR was done from 25 to 40 cycles with increments of 5-cycles, except for β₂-microglobulin, which was done at 18, 22, 25, and 30 cycles. The PCR reaction products were analyzed on a 3% agarose gel stained with ethidium bromide, and the amount of DNA was quantitated as band intensities using GelDoc software from BioRAD (Hercules, Calif.). The level of expression of each gene was normalized against the level of β₂-microglobulin expression between these two species. The relative expression between human and baboon cDNA was estimated by measuring the ratio of intensity of DNA product, comparing only those measurements which fell within the linear range of PCR amplification cycles; multiple determinations, when performed, were averaged. The sequences of Forward (F) and Reverse (R) primers are: Transmembrane 4 superfamily member 4 (TM4SF4), F

Transmembrane 4 superfamily member 4 (TM4SF4),
F-AAGCGATTTGCGATGTTCACCTC,
R-GAGGCTCTCGGCACTTGTTCC;
Protein tyrosine kinase 9 (PTK9),
F-GATTCCTTTGTTTTACCCCTGTTGGAG,
R-TTGCTGC ATACAACATTTTTTGAC;
Cytochrome P450, subfamily I (dioxininducible),
polypeptide 1 (glaucoma 3,
primary infantile) (CYP1B1),
F-GTAATGGTGTCCCAGTATAA GTAATGAG-3′,
R-TCATGAATGCTTTTAGTGTGTGC-3′;
Colony stimulating factor 3 receptor
(granulocyte) (CSF3R),
F-CTGAAGTTATAGGAAACAAGC ACAAAAGGC,
R-GCCC ATGACTAAAAACTACCCCAGC;
Beta-2-microglobulin (B2M),
F-CCTGAATTGCTA TGTGTCTGGG,
R-TGATGCTGCTTACATGTCTCGA.
R82595,F: GCTCGTAGCAACATTTTCGTAATAGCC,
R: GGACCCATCGTGGTT ACCGTG;
AA676327, F-ATATTTCGGTAACTTTTGACCCTAAG,
R: CAGGGGCAA TTTTGAGGTATG;
R85439,F: GGCAGGGCTCTAAATGGAAGTAGTTG,
R: CTCAGAAGTGTTTTGTAGCAAGGCTGC,
AA487912,F: AAACAGTGACTTATCCCGCTAC CC,
R: GGGTGGGTTTACTCTTAGAATCGC;
N25920,F: CAGATGGAGGGTTTATGAGTGAGGCTGG,
R: GCTTGTTCTTTGGGGATTGTGGTGC;
R05886,F: TAGGCG TGAGAAGCATATAGAGGC,
R: AGTGAATAAGCAAGAAATCAGGGTG;
N74363, F: ACAAAGGGCTGTTTACTGAGAGACCTGAGC,
R: GGCATAACTCACACCCATT TGTTTACCTGC;
N55359,F: GGCAGAATCTACTGGGCATCTTGTAATC,
R: AGTTTTGGTGGTCCAGGGAAGGTAC.

VII. Correlation of Gene Expression Between Human and Baboon CD34⁺ Cells

CD34⁺ cell populations were isolated from bone marrow aspirates by immunomagnetic cell sorting using antibodies that represent the best selection of undifferentiated and multi-potent marrow cells in human and baboon marrow. The human marrow cell population was 90% pure, as determined by FACS analysis with anti-human CD34⁺ antibody. Using the same method, the baboon CD34⁺ cells measured 77% purity. This measurement in baboon cells is an underestimate of the true degree of purity due to the relative non-specificity of the anti-human CD34⁺ antibody K6.1 (used for quantitation by flow cytocytometry) with baboon cells, resulting in a weaker fluorescence signal and lower estimates of purity than can be measured in comparable human cells, but it is within the range that we normally observe with this method.

Radioactively-labeled RNA-based probes prepared from each cellular population were hybridized to five nylon filter membrane arrays (GeneFilters releases 200-204, containing a total of 25,920 cDNAs) and phosphoimaged, and the resultant image was analyzed to determine the relative hybridization signal intensity for each cDNA with each probe. Each cDNA on the array is derived from a single clone from the IMAGE consortium (http://image.llnl.gov) representing the 3′-end of a unique UniGene cluster. All data were obtained by sequential hybridization to a single filter set, in order to provide the most accurate comparisons between probes and avoid variability in cDNA spotting. Duplicate experiments were performed when possible, but were limited by the lifetime of the filters, which in general could be successfully re-hybridized no more than 3 to 4 times. It was not possible to use pooled baboon marrow donors because of the limited availability of animals, and thus pooled human donors were not used either, recognizing that the methods of the present invention are not sensitive enough to detect small differences between individual donors.

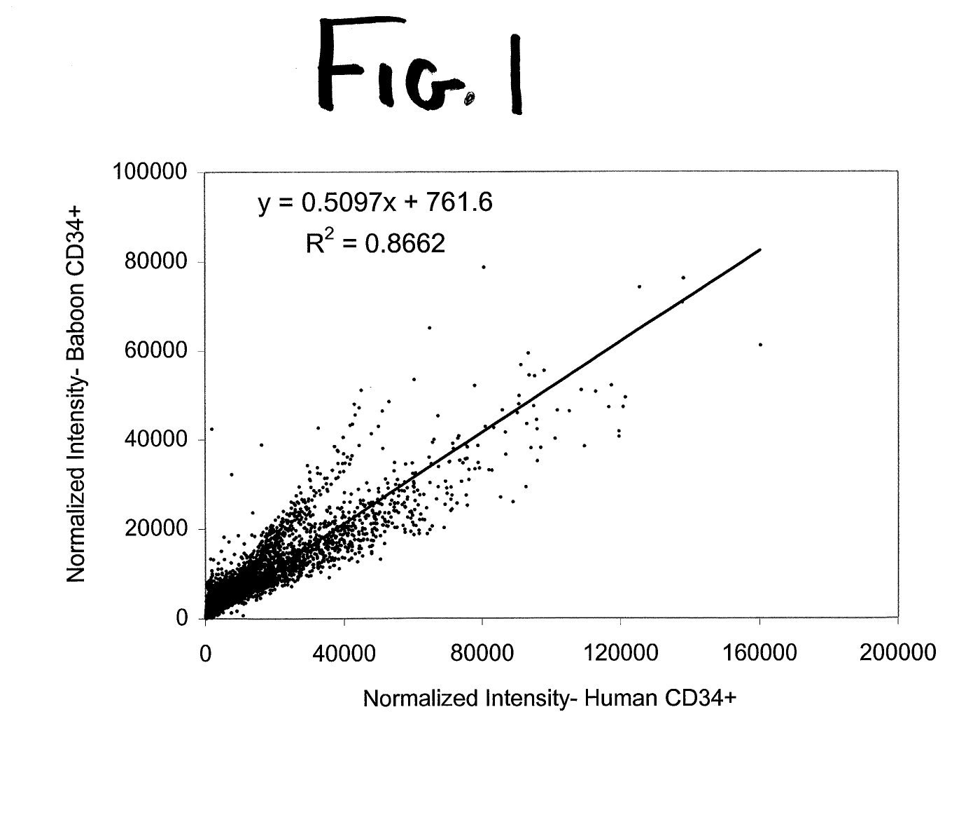

Normalized signal intensities for individual cDNA spots from these hybridizations were compared by scatter analysis, and revealed that the gene expression patterns in human and baboon cells were very similar, with an overall correlation of 0.87. The composite data for all hybridizations is summarized on a scatter plot (FIG. 1). The measured raw intensity of the hybridization signal relative to the filter background is used as an indicator of the relative abundance of the cDNA. For these experiments, a cut-off level of raw intensity (non-normalized) of 3-fold over background was used to indicate that a gene is definitively expressed in human cells. By this criteria, human CD34⁺ cells displayed positive expression for approximately 15,970 (62%) of the 25,920 cDNAs present on these filters. This gene list excludes many housekeeping genes, which are measured on the GeneFilters as hybridization controls but are not included for normalization by Pathways II software. (For information on all the spotted cDNA for each filter including the housekeeping genes, refer to the Research Genetics's ftp website, ftp://ftp.resgen.com/pub/genefilters/).

The baboon-derived probes showed a consistently higher hybridization background, approximately three-fold higher, than the human-derived probes, so it was not possible to apply the same cut-off level for this species (baboon). However, 13,447 cDNAs (84%) gave a signal with the baboon probe that varied less than 2-fold from the human level of expression, while almost all of the genes (15,407 or 96.5%) were expressed within 3-fold of each other. Much of the measured differences in expression level is likely to be due to experimental variation; about 3% of cDNAs will vary more than 3-fold upon repeat hybridization with these probes. Other measured differences between the human and baboon RNAs probably reflect true differences in expression, but in either case, the variation is not great. Thus human and baboon CD34⁺ cells express virtually the same spectrum of genes, with similar though not identical levels of expression.

VIII. cDNAs Highly Expressed in Both Human and Baboon

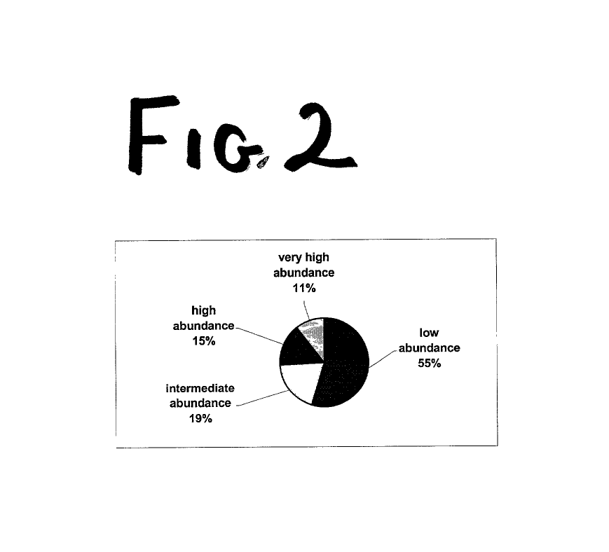

The 15,407 cDNAs that are commonly expressed in human and baboon CD34⁺ cells were arbitrarily placed into several groups (FIG. 2) based on their spot intensities relative to background in the human data set: very high abundance (100-fold and over), 1,619 cDNAs; high abundance (25-fold to <100-fold), 2,376 cDNAs; intermediate abundance (10-fold to <25-fold), 2,976 cDNAs; low abundance (3-fold to <10-fold), 8,436 cDNAs.

The very highly-abundant genes identified by Pathways II analysis were then updated to the most current UniGene release (version 118, April 2000), and examined in detail. A total of 1,554 UniGene clusters remained after updating. This list included 595 named genes, and 959 ESTs and uncharacterized cDNAs. This list of highly-abundant genes and ESTs is available as an appendix to the online version of this article, and is also available on our hematopoietic stem cell website (http://westsun.hema.uic.edu/html/expression.html). The named genes represent a wide variety of functional categories such as growth factors and cytokines, receptors and cell surface molecules, intracellular signalling molecules, cell cycle proteins etc. A sample of these genes, sorted by functional category, are given in Table 1. Note that this list includes many of the genes (typed in bold) that would be expected to be present in CD34⁺ cells, such as receptors for IL3 and colony stimulating factor 3. Interestingly, many expected hematopoietic genes are not in this category, as their level of expression is relatively low; for example, the CD34 antigen is expressed at a relatively low level, only 6-fold above background (for human).

A large fraction, over 61% of these highly-expressed cDNAs, are ESTs and uncharacterized cDNAs. Although many of these genes are uncharacterized, the UniGene database provides some information about their similarity to known proteins. Furthermore, many of the named genes represent full length cDNAs that have not been fully studied or are only partially characterized, though some function is suggested by homology to known proteins. A partial list of some of these interesting ESTs and partially characterized named genes are given in Table 2. Further characterization of the ESTs in this database represents a potential wealth of new information about the CD34⁺ transcriptosome.

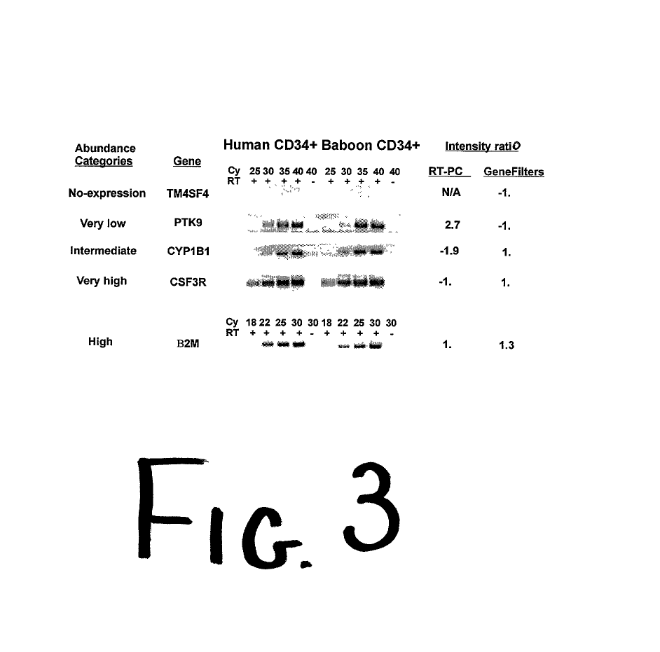

Several known genes from each abundance category were selected to verify their relative level of expression in both species by semi-quantitative RT-PCR. Representative examples are shown in FIG. 3. Each gene tested was found to be expressed at comparable levels in both species, although the abundance category was not always accurate, especially in the lower abundance genes. For example, PTK9 is expressed at a level 5-fold above background in human cells, but its signal appears stronger than CYPB1, measured at 20-fold above background. The measurement of the absolute level of expression of a cDNA using filter hybridization is related to many factors, including the amount of DNA placed on the filter (which cannot be accurately controled), and the efficiency of hybridization. Thus, the assignment of a gene to a relative abundance category can only be regarded as approximate, and may require additional confirmation.

IX. Species-specific Transcripts

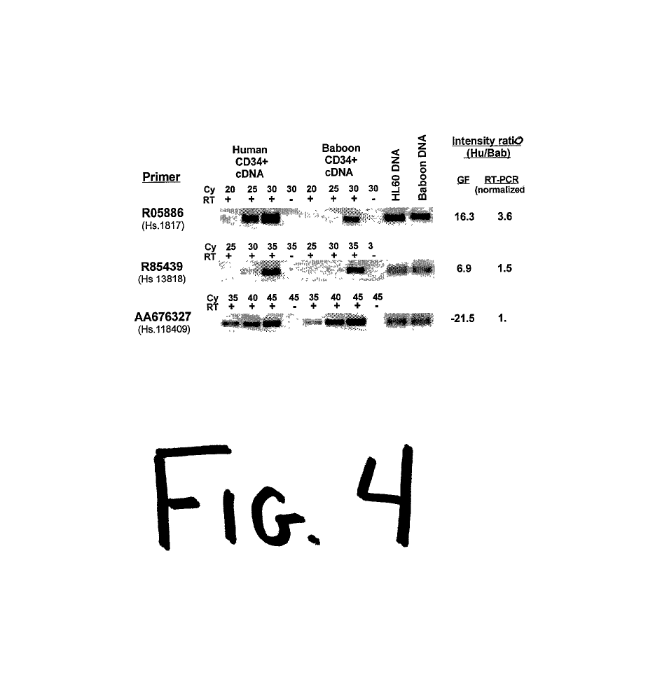

Although there were a number of cDNAs which did not appear to be highly-correlated (that is, their expression varied more than 3-fold between species), there were a few genes whose measured intensity suggested that they were preferentially expressed in only one species. To identify these genes, the GeneFilters dataset was searched for cDNAs which were unexpressed in one species (defined as a raw intensity of less than 3-fold background), and were clearly expressed in the other species (>3-fold background) with a normalized intensity ratio of >3 fold between species. There were only 14 cDNAs which fit this criteria, 6 baboon and 8 human, which includes 6 known genes and 8 ESTs. PCR primer pairs for all 14 cDNAs were designed to match the sequence of the human clones which were present on the filter membrane; the pairs were tested for their ability to amplify both genomic DNA and reverse-transcribed RNA from both species. Six primer pairs (4 human and 2 baboon) were successfully validated on both species in this manner, and these were further analyzed by semi-quatitative RT-PCR, using an additional normalization factor for PCR efficiency on genomic DNA from both species. The ratio of expression for each gene, as measured by semi-quantitative RT-PCR, is compared to that measured on GeneFilters, is summarized in Table 3, and representative examples are shown in FIG. 4. The use of normalization factors, one as a control for PCR efficiency of human-specific primers against baboon, and another for RT-reaction, adds complexity and probably some inaccuracy in quantitative comparison of gene expression between the two species, so the measured levels can only be regarded as estimates. Nonethless, most of the genes, except for two designated by Unigene Cluster ID Hs.1817 and Hs.215595, showed little if any differential between the two species and fall within 3-fold of each other, well within the arbitrary cut-off that was set for Table 1. Only Hs.1817 and Hs.215595 were confirmed to be expressed at somewhat higher levels in human than baboon (3.6-fold and 5.4-fold, respectively), although the differences were small and not as great as was measured on the filters. The results showing differential expression of Hs.1817 are included in FIG. 4. Thus, none of the 6 genes tested showed expression restricted to one species, though some appear to be differentially expressed. This result suggests that the experimental variation in the GeneFilter hybridization system is greater than the actual variation between the two species. Additional work will be required to determine if there are any bonafide species-specific genes within either species.

By its ability to simultaneously detect and quantitate the expression level of thousands of genes at one time, cDNA array technology is greatly improving our understanding of the complex patterns of gene expression in eukaryotic cells. In the present invention this technology is used to profile the gene expression patterns of CD34⁺ marrow cells in human and baboon cell populations. Baboon-derived probes are suitable for use on human cDNA arrays with some limitations.

Expression studies on cDNA arrays require a fairly large number of cells to isolate an appropriate amount of RNA for probe preparation. Because of this constraint, it was necessary to purify the CD34⁺ cells by immunomagnetic columns rather than FACS, which would require prolonged sorting. The stress imposed by the prolonged sorting time required to prepare this number of cells can dramatically reduce cell viability and yield of CD34⁺ cells, and may alter their gene expression profile. Because of the weak cross-reactivity of anti-human CD34⁺ antibody against baboon CD34⁺ antigen, it is difficult to accurately determine the level of purity of baboon CD34⁺ cell population. Thus, the purity of baboon CD34⁺ may be an under-representation. At any rate, in spite of the heterogeneity of the cell populations examined and the limited number of subjects studied, we determined that bone marrow cells derived from the two closely-related species have similar patterns of gene expression. Although many molecular similarities were expected between human and baboon CD34⁺ cells, the results suggest that the transcriptosomes are nearly identical, supporting experimental studies over the years which have demonstrated similar biologic activity. Inability to identify any species-specific transcripts further supports the similarity of the two populations.

The probe derived from the 3′ end of baboon RNA recognized human cDNAs fairly well under appropriate hybridization conditions. The concentration of Cot1 and oligo-dT which are used for blocking non-specific hybridization were found to be very crucial for this purpose. This is not unexpected, because the genomes of the two species are highly conserved, and both have Alu sequences (Hamdi et al., 2000; Hamdi et al., 1999). In general, higher background resulting from the baboon probe may be a reflection that the Alu content is not identical, and might benefit from a readjustment of the hybridization conditions, especially Cot1 and oligo-dT concentration. Nonetheless, the hybridization signal obtained with the baboon probe was strong and resulted in a very similar pattern to the one obtained with human probe. This suggests that human cDNA arrays are accurate substrates for baboon experiments, thereby facilitating translation of experimental results with this animal model to human relevance.

The studies were performed using a cDNA filter array system and radioactive probes. Although there may be limitations to the use of filters rather than solid cDNA supports, GeneFilters were especially attractive for these studies because they contain over 25,000 different cDNA clones, which covers an estimated 50% of the human genome, including a large proportion of uncharacterized cDNAs (ESTs).

The use of GeneFilters dictated an experimental design that differs from those using cDNA arrays on solid supports. Because two probes cannot be simultaneously hybridized and compared in a single experiment, reproducibility is maximized when the same membrane is re-used for sequential hybridization to compare probes from different RNA sources. Due to limited membrane lifetime, it is not possible to repeat multiple experiments, or compare expression patterns among different subjects, so the sampling error may be greater than for other methods for cDNA analysis. Thus, the results presented here should be regarded as a starting point for further confirmation and analysis.

The most reliable data obtained on these filters is the comparison of relative signal strength for a single gene between two probes. An absolute determination of the relative expression between different genes on one filter is less reliable, because the signal strength is dependent on many factors, such as the length of the clone and the hybridization efficiency of the probe, and the relative inaccuracies of spotting small amounts of DNA. Cross-comparisons of cDNA on different filters is less reliable. Here, the intensity of the hybridization signal relative to background was used as a means of comparison between filters, in order to estimate the relative level of expression of all of the genes on this dataset, recognizing that this is only an approximate-though generally reliable-measurement.

The gene list resulting from this study represents a selection of some of the most highly-abundant genes in hematopoietic cells, and provides a starting point to develop a profile of the predominant cDNAs that define CD34⁺ cells. Interestingly, a significant fraction of the genes identified on these filters are not unique to hematopoietic cells, but are present in other tissues. This reinforces the concept that a tissue is defined not only by the expression of tissue-specific genes, but also by the overall pattern and relative abundance of the sequences which are more widely expressed. Perhaps the most interesting result is the fact that many of the cDNAs expressed at high level in these cells have not yet been identified or characterized. The gene and EST list presented here, and their relative expression levels, represent a potential wealth of new information about bone marrow stem cells and hematopoietic progenitor cells.

A comprehensive description of the CD34⁺ transcriptosome with reference to the UniGenes represented in GeneFilters will be useful. Although by no means complete, the list of over 15,000 cDNAs disclosed comprises an estimated 25-50% of the genes expressed in CD34⁺ cells, and also provides an approximation of their relative abundance. This gene set will be useful for the production of customized cDNA arrays for bone marrow studies.

### DOCUMENTS CITED

Alizadeh et al. (2000) “Distinct types of diffuse large B-cell lymphoma identified by gene expression profiling. “Nature” 403:503-511.

Andrews R-G, Singer J-W, Bernstein I-D. Monoclonal antibody 12-8 recognizes a 115-kd molecule present on both unipotent and multipotent hematopoietic colony-forming cells and their precursors. Blood. 1986; 67:842-845.

Andrews R G, Bryant E M, Bartelmez S H, et al. CD34⁺ marrow cells, devoid of T and B lymphocytes, reconstitute stable lymphopoiesis and myelopoiesis in lethally irradiated allogeneic baboons. Blood. 1992;80:1693-1701.

Brandt J E, Galy A H, Luens K M et al. Bone marrow repopulation by human marrow stem cells after long-term expansion culture on a porcine endothelial cell line. Exp. Hematol. 1998; 26(10):950-61.

Brandt J E, Bartholomew A M, Fortman J D, et al. Ex vivo expansion of autologous bone marrow CD34⁺ cells with porcine microvascular endothelial cells results in a graft capable of rescuing lethally irradiated baboons. Blood. 1999;94:106-113.

Goodell M A, Rosenzweig M, Kim H, et al. Dye efflux studies suggest that hematopoietic stem cells expressing low or undetectable levels of CD34 antigen exist in multiple species. Nat. Med. 1997;3:1337-1345.

Hamdi H, Nishio H, Zielinski R, Dugaiczyk A. Origin and phylogenetic distribution of Alu DNA repeats: irreversible events in the evolution of primates. J. Mol. Biol. 1999;289: 861-871.

Hamdi H-K, Nishio H, Tavis J, Zielinski R, Dugaiczyk A. Alu-mediated phylogenetic novelties in gene regulation and development. J. Mol. Biol. 2000;299: 931-939.

Liao D, Pavelitz T, Weiner A-M. Characterization of a novel class of interspersed LTR elements in primate genomes: structure, genomic distribution, and evolution. J. Mol. Evol. 1998; 46: 649-660.

Link H, Arseniev L, Bahre 0, Kadar J-G, Diedrich H, Poliwoda H. Transplantation of allogeneic CD34⁺ blood cells. Blood. 1996;87:4903-4909.

Nachtman R G, Abdullah J M, Jurecic R. Cloning and functional characterization of novel genes preferentially expressed in hematopoietic cells [Abstract]. 29th Annual Meeting of the International Society for Experimental Hematology, Tampa, Fla.:2000;28:108.

Phillips R L, Ernst R E, Brunk B, et al. The genetic program of hematopoietic stem cells. Science. 2000;288:1635-1640.

Pierelli L, Scambia G, Bonanno G, et al. CD34+/CD105+ cells are enriched in primitive circulating progenitors residing in the G0 phase of the cell cycle and contain all bone marrow and cord blood CD34+/CD38^{low/-} precursors. Br. J. Haematol. 2000;108:610-620.

Trezise A-E, Godfrey E-A, Holmes R-S, Beacham I-R. Cloning and sequencing of cDNA encoding baboon liver alcohol dehydrogenase: evidence for a common ancestral lineage with the human alcohol dehydrogenase b-subunit and for class I ADH gene duplications predating primate radiation. Proc. Natl. Acad. Sci., U.S.A. 1989;86: 5454-5458.

Ueda T, Yoshino H, Kobayashi K, et al. Hematopoietic repopulating ability of cord blood CD34⁺ cells in NOD/Shi-scid mice. Stem Cells. 2000;18:204-213.

TABLE 1
Representative sample of very highly-abundant named genes
in human and baboon CD34+ cells, by functional category.

| | | | |
|---|---|---|---|
| UniGene | Genbank | | |
| Cluster ID | Accession # | Description | Gene name |

I. Growth Factors/Cytokines

| | | | |
|---|---|---|---|
| Hs.56023 | AA262988 | Brain-derived neurotrophic factor | BDNF |
| Hs.180577 | AA496452 | Granulin | GRN |
| Hs.251664 | N54596 | Insulin-like growth factor 2 | IGF2 |
| Hs.82045 | AA968896 | Midkine | MDK |
| Hs.118787 | AA633901 | Transforming growth factor, beta-induced | TGFBI |

II. Cell Surface/Receptors

| | | | |
|---|---|---|---|
| Hs.85258 | AA443649 | CD8 antigen, alpha polypeptide | CD8A |
| Hs.75626 | AA136359 | CD58 antigen | CD58 |
| Hs.75564 | AA456183 | CD151 antigen | CD151 |
| Hs.2175 | AA443000 | Colony stimulating factor 3 precursor receptor | CSF3R |
| Hs.110849 | AA098896 | Estrogen-related receptor alpha | ESRRA |
| Hs.89650 | R68805 | Integral transmembrane protein 1 | ITM1 |
| Hs.1724 | AA903 183 | Interleukin 2 receptor, alpha | IL2RA |
| Hs.172689 | W44701 | Interleukin 3 receptor, alpha | IL3RA |
| Hs.47860 | N63949 | Neurotrophic tyrosine kinase, receptor, type 2 | NTRK2 |
| Hs.82028 | AA487034 | Transforming growth factor, beta receptor II | TGFBR2 |

III. Intracellular signalling molecules

| | | | |
|---|---|---|---|
| Hs.166154 | AA463972 | jagged 2 | JAG2 |
| Hs.86859 | H53703 | Growth factor receptor-bound protein 7 | GRB7 |
| Hs.78793 | AA447574 | Protein kinase C, zeta | PRKCZ |
| Hs.62402 | AA890663 | p21/Cdc42/Rac1-activated kinase 1 (yeast Ste20-related) | PAK1 |
| Hs.75074 | AA455056 | Mitogen-activated protein kinase-activated protein kinase 2 | MAPKAPK2 |
| Hs.73799 | AA490256 | Guanine nucleotide binding protein, alpha inhibiting activity | GNAI3 |
| Hs.75217 | AA293050 | Mitogen-activated protein kinase kinase 4 | MAP2K4 |
| Hs.138860 | AA443506 | Rho GTPase activating protein 1 | ARHGAP1 |

V. Cell cycle proteins

| | | | |
|---|---|---|---|
| Hs.82906 | AA464698 | Cell division cycle 20, S. cerevisiae homolog | CDC20 |
| Hs.153752 | AA448659 | Cell division cycle 25B | CDC25B |
| Hs.172405 | T81764 | Cell division cycle 27 | CDC27 |
| Hs.77550 | AA459292 | CDC28 protein kinase 1 | CKS1 |

V. Apoptosis/Anti-apoptosis factors

| | | | |
|---|---|---|---|
| Hs.82890 | AA455281 | Defender against cell death 1 | DAD1 |
| Hs.227817 | AA459263 | BCL2-related protein A1 | BCL2A1 |

VI. Cytoskeleton/Cell matrix/Adhesion

| | | | |
|---|---|---|---|
| Hs.183805 | AA464755 | Ankyrin 1, erythrocytic | ANK1 |
| Hs.171271 | AA442092 | Catenin, beta 1 | CTNNB1 |
| Hs.75617 | AA430540 | Collagen, type IV, alpha 2 | COL4A2 |
| Hs.71346 | AA400329 | Neurofilament 3 (150 kD medium) | NEF3 |
| Hs.78146 | R22412 | Platelet/endothelial cell adhesion molecule | PECAM1 |
| Hs.75318 | AA180912 | Tubulin, alpha 1 | TUBA1 |

VII. Metabolic proteins

| | | | |
|---|---|---|---|
| Hs.278399 | AA844818 | Amylase, alpha 2A; pancreatic | AMY2A |
| Hs.155097 | H23187 | Carbonic anhydrase II | CA2 |
| Hs.81097 | AA862813 | Cytochrome c oxidase subunit VIII | COX8 |
| Hs.172690 | AA456900 | Diacylglycerol kinase alpha | DGKA |
| Hs.944 | AA401111 | Glucose phosphate isomerase | GPI |
| Hs.2795 | AA489611 | Lactate dehydrogenase A | LDHA |

VIII. Transcription factors/Activators/Inhibitors

| | | | |
|---|---|---|---|
| Hs.158195 | AA250730 | Heat shock transcription factor 2 | HSF2 |
| Hs.22554 | AA252627 | Homeo box B5 | HOXB5 |
| Hs.153837 | N29376 | Myeloid cell nuclear differentiation antigen | MNDA |
| Hs.79334 | AA633811 | Nuclear factor, interleukin 3 regulated | NFIL3 |
| Hs.74002 | AA495962 | Nuclear receptor coactivator 1 | NCOA1 |
| Hs.192861 | N71628 | Spi-B transcription factor | SPI-B |
| Hs.3005 | AA284693 | Transcription factor AP-4 | TFAP4 |

Genes highlighted in bold are known to be expressed in hematopoietic tissues
GenBank accession # specifies a cDNA from a specific IMAGE clone spotted on the GeneFilter membrane

TABLE 2
Selection of very highly-abundant ESTs and partially
characterized cDNAs in human and baboon CD34+ Cells.

| UniGene | Genbank | | Gene |
|---|---|---|---|
| Cluster ID | accession # | Description | Name |
| Hs.155545 | AA423944 | 37 kDa leucine-rich repeat (LRR) protein | P37NB |
| Hs.42322 | AA682795 | A kinase (PRKA) anchor protein 2 | AKAP2 |
| Hs.155586 | N90281 | B7 protein | B7 |
| Hs.118724 | AA406285 | DR1-associated protein 1 (negative cofactor 2 alpha) | DRAP1 |
| Hs.183738 | AA486435 | FERM, RhoGEF (ARHGEF) and pleckstrin domain protein 1 (chondrocyte-de | FARP1 |
| Hs.9914 | AA701860 | follistatin | FST |
| Hs.147189 | R01638 | HYA22 protein | HYA22 |
| Hs.23119 | AA455272 | ITBA1 gene | ITBA1 |
| Hs.20149 | AA425755 | leukemia associated gene 1 | LEU1 |
| Hs.118796 | AA872001 | Annexin A6 | ANX6 |
| Hs.102948 | AA127096 | enigma (LIM domain protein) | ENIGMA |
| Hs.41007 | AA147980 | HSPC158 protein | HSPC158 |
| Hs.89650 | R68805 | integral membrane protein 1 | ITM1 |
| Hs.69855 | AA504682 | NRAS-related gene | D1S155E |
| Hs.172589 | AA485992 | nuclear phosphoprotein similar to S. cerevisiae PWP1 | PWP1 |
| Hs.2815 | N63968 | POU domain, class 6, transcription factor 1 | POU6F1 |
| Hs.59545 | AA195036 | ring finger protein 15 | RNF15 |
| Hs.172052 | AA732873 | serine/threonine kinase 18 | STK18 |
| Hs.444 | H87351 | serine/threonine kinase 19 | STK19 |
| Hs.98874 | AA436479 | similar to proline-rich protein 48 | LOC54518 |
| Hs.151689 | AA043458 | zinc finger protein 137 (clone pHZ-30) | ZNF137 |
| Hs.169832 | AA120779 | zinc finger protein 42 (myeloid-specific retinoic acid-responsive) | ZNF42 |
| Hs.104746 | AA406206 | ESTs, Highly similar to NBL4 PROTEIN [M. musculus] | |
| Hs.58643 | AA490900 | ESTs, Highly similar to JAK3B [H. sapiens] | |
| Hs.42733 | W85875 | ESTs, Weakly similar to BC-2 protein [H. sapiens] | |
| Hs.90020 | AA626316 | ESTs, Weakly similar to KINESIN LIGHT CHAIN [H. sapiens] | |
| Hs.118739 | AA521439 | ESTs, Weakly similar to phosphoinositide 3-kinase [H. sapiens] | |
| Hs.84640 | W93317 | ESTs, Weakly similar to proline-rich protein MP3 [M. musculus] | |
| Hs.24956 | AA454654 | ESTs, Weakly similar to SH3 domain-binding protein SNP70 [H. sapiens] | |
| Hs.36779 | H53499 | ESTs, Weakly similar to Zn-finger-like protein [H. sapiens] | |

GenBank accession # specifies a cDNA from a specific IMAGE clone spotted on the GeneFilter membrane

TABLE 3
Comparison of expression level of apparent
species-specific genes by semi-quantitative RT-PCR.

| | | | Hu/Bab | Hu/Bab | |
|---|---|---|---|---|---|
| | | | Intensity | Intensity | |
| Specificity | Unigene | Primer | Ratio | Ratio (by | Gene |
| (by GFs) | Cluster ID | Pair | (by GFs) | RT-PCR) | Name |
| Human | Hs.1817 | R05886 | 16.3 | 3.6 | MPO |
| Human | Hs.13818 | R85439 | 6.9 | 1.5 | ESTs |
| Human | Hs.47956 | N55359 | 4.9 | * | ESTs |
| Human | Hs.43708 | N25920 | 3.7 | −1.9 | EST |
| Human | Hs.215595 | AA487912 | 3.2 | 5.4 | GNB1 |
| Baboon | Hs.118409 | AA676327 | −21.5 | 1.8 | ESTs |
| Baboon | Hs.107308 | R82595 | −19.3 | 1.2 | cDNA |
| Baboon | Hs.114593 | N74363 | −9.2 | * | ESTs |

Primer pairs were named after the GenBank Accession number specifying a cDNA from a specific IMAGE clone spotted on GeneFilter membrane.
GF, GeneFilters; MPO, myeloperoxidase; GNB1, Guanine nucleotide binding protein (G protein), beta polypeptide 1; cDNA, Homo sapiens uncharacterized gene.
*indicates no expression in either species. Negative intensity ratio indicates higher expression in baboon than in human.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

We claim:

1. A database comprising the nucleotide sequences of a plurality of cDNA molecules selected for the analysis of hematopoietic tissue, said tissue including bone marrow, peripheral blood, stem cells, transplanted marrow, and leukemia cells from human and related primates including baboon.

2. The database of claim 1 comprising molecules having the nucleotide sequences designated by the unique identifiers as shown in Appendix A.

3. A microchip comprising the database of claim 1 or a subset thereof.

4. A method for selecting a database containing expressed genes from primate CD34+ cells, said method comprising:
(a) selecting genes whose expression level is greater than or equal to 7-fold above background in human cells; and
(b) further selecting genes selected in (a) whose expression levels differ between humans and baboons by 3-fold or less.

5. The method of claim 4, wherein gene expression is measured by the gene filter method.

6. A computer system comprising:
(a) a database containing nucleotide sequences pertaining to a plurality of biomolecular sequences selected in accord with the method of claim 4;
(b) a first hierarchy of function categories into which at least some of said biomolecular sequences are grouped;
(c) a user interface allowing a user to selectively view information regarding said plurality of said biomolecular sequences as it relates to said first hierarchy.

7. The computer system of claim 7, wherein the biomolecular sequences are selected from the group consisting of ESTs, full-length sequences, and combinations thereof.

8. The computer system of claim 7, wherein the user interface allows the user to selectively view information regarding a subset of said plurality of said biomolecular sequences which subset is grouped in both a selected category and for a selected application.

9. A computer-implemented method for managing information relating to hematopoietic analyses said method comprising:
(a) a first identifier identifying a target sample applied to a probe array chip;
(b) a second identifier identifying said probe array chip to which said target sample was applied; and
(b) creating an electronically-stored chip table, said chip table storing a record for said polymer probe array chip, said chip record comprising
(i) a plurality of fields storing at least one of a plurality of data identifiers, including:
(ii) said second identifier identifying said probe array chip, and
(iii) a third identifier specifying a layout of probes on said probe array chip.

10. A database method for analyzing hematopoetic tissue said method comprising:
(a) providing a first database comprising a first plurality of records, one for each of a plurality of cDNA sequences, said records having at least one of a plurality of fields storing:
(i) a first attribute identifying a target sample applied to a probe array chip;
(ii) a second attribute identifying said probe array chip to which said target sample was applied; and
(b) providing a second database comprising a second plurality of records for said probe array chip, said records having at least one of a plurality of fields storing:
(i) said second attribute identifying said probe array chip; and
(ii) a third attribute specifying a layout of probes on said probe array chip.

11. The database method for analyzing gene expression information of claim 10, wherein said first database and said second database are relational database tables.
